(19) United States
(12) Patent Application Publication
(10) Pub. No.: US 2025/0310752 A1
(43) Pub. Date: Oct. 2, 2025

(54) METHOD TO ENABLE ADAPTABLE OPERATION AND SERVICE PROVISION OF A MOBILE NETWORK

(71) Applicant: Lenovo (Singapore) Pte. Ltd., Singapore (SG)

(72) Inventor: Apostolis Salkintzis, Athens (GR)

(21) Appl. No.: 18/865,641

(22) PCT Filed: Jun. 23, 2022
(86) PCT No.: PCT/EP2022/067288

§ 371 Date: Nov. 13, 2024

(30) Foreign Application Priority Data
May 13, 2022 (GR) 20220100392

(51) Int. Cl. H04W 8/20; H04L 9/00

(52) U.S. Cl. CPC H04W 8/20; H04L 9/50

(57) ABSTRACT

Various aspects of the present disclosure relate to enabling adaptable operation and service provision of a mobile network. A network entity comprising a first network function is configured to receive blockchain information associated with a user equipment (UE), the blockchain information indicating a blockchain address; identify a second network function based on the blockchain information; send, to the identified second network function, a request for identifying a blockchain asset associated with the blockchain address; receive, from the second network function, and in response to the request, blockchain asset information corresponding to the identified blockchain asset; and update subscription data of the UE based on the blockchain asset information.

### FIELD OF THE INVENTION

The present invention relates to methods and apparatuses for enabling a mobile network to identify blockchain assets owned by mobile network users and adapt its operation, and/or service provision to user nodes of the network, based on the identified blockchain assets, or changes in the status of the blockchain assets.

### BACKGROUND

Methods for identifying blockchain assets (e.g., NFTs) owned by blockchain users are well-known in the prior art. However, methods for a mobile network to identify blockchain assets (e.g., NFTs) owned by mobile users and adapt mobile network operation (e.g., provide enhanced QoS services, or provide access to special features) based on the identified blockchain assets are not known.

### SUMMARY OF THE INVENTION

Disclosed herein are procedures for enabling a mobile network to identify blockchain assets owned by mobile network users and adapt its operation, and/or service provision to user nodes of the network, based on the identified blockchain assets, or changes in the status of the blockchain assets.

In an aspect, there is provided a first network function in a wireless communication network, the first network function comprising a receiver arranged to receive blockchain information associated with a user equipment apparatus (UE), the blockchain information indicating a blockchain address. The first network function further comprises one or more processors arranged to, using the blockchain information, identify a second network function in the wireless communication network. The first network function further comprises a transmitter arranged to send, to the identified second network function, a request for identifying a blockchain asset, the blockchain asset being associated with the blockchain address. The receiver is further arranged to receive, from the second network function, responsive to sending the request, blockchain asset information corresponding to the identified blockchain asset. The one or more processors are arranged to, using the received blockchain asset information, update subscription data of the UE.

The first network function may be User Data Management function (UDM).

The one or more processors may be arranged to, using the received blockchain asset information, update Access Management (AM) subscription data associated with the UE. The one or more processors may be further arranged to, responsive to updating the AM subscription data, inform an AM Function (AMF) of the wireless communication network that the AM subscription data associated with the UE has been updated.

The one or more processors may be further arranged to, using the received blockchain asset information, configure the wireless communication network to provide a service to the UE, the service being dependent on the blockchain asset.

The receiver may be arranged to receive the blockchain information from the AMF of the wireless communication network, the blockchain information being comprised in a subscription request from the AMF requesting that the AMF receives updated AM subscription data for the UE from the first network function.

The blockchain information may comprise an identifier for a blockchain that stores the blockchain asset, and the one or more processors may be arranged to identify the second network function using the identifier for the blockchain.

The one or more processors may be arranged to identify the second network function using services of a Network Repository Function (NRF).

The transmitter may be arranged to send, to the identified second network function, a subscription request, the subscription request being a request to identify one or more blockchain assets associated with the UE and/or a request that the first network function be informed when one or more blockchain assets associated with the UE change.

The requested blockchain asset and/or the blockchain asset information may comprise one or more of the following: a non-fungible token (NFT); an identifier for an NFT; one or more attributes of an NFT; metadata of an NFT; or a report comprising one or more of the above.

The subscription data associated with the UE may be updated to indicate one or more of the following: that the UE is permitted to access a certain network slice; that the UE is permitted to access a certain Data Network Name (DNN); that the UE is permitted to access a certain Local Access DNN (LADN); that the UE is permitted to access a certain Closed Subscriber Group (CSG); that the UE is to be provided with unlimited mobile data; that the UE is to be provided enhanced Quality of Service (QoS) support; that the UE is to be provided with ultra-reliable and low-latency communication (URLLC); that the UE is not permitted to access a certain network slice; that the UE is not permitted to access a certain DNN; that the UE is not permitted to access a certain LADN; that the UE is not permitted to access a certain CSG; that the UE is not to be provided with unlimited mobile data; that the UE is not to be provided enhanced QoS support; or that the UE is not to be provided with URLLC.

In a further aspect, there is provided a second network function in a wireless communication network, the second network function comprising a receiver arranged to receive, from a first network function in the wireless communication network, a request for blockchain asset information corresponding to a blockchain asset. The blockchain asset is associated with a UE. For example, the UE may store, possess, or have access to credentials (e.g., a private key) of a blockchain address and this blockchain address may be the owner of the blockchain asset which is stored in the blockchain. The blockchain asset information is for determining one or more services to be provided to the UE by the wireless communication network. The second network function further comprises one or more processors arranged to, using the request, determine a blockchain address associated with the blockchain asset, and, using the blockchain address, acquire the blockchain asset information. The second network function further comprises a transmitter arranged to send, to the first network function, the blockchain asset information.

The second network function may be an Application Function (AF).

The blockchain asset and/or the blockchain asset information may comprise one or more of the following: a non-fungible token, NFT; an identifier for an NFT; one or more attributes of an NFT; metadata of an NFT; or a report comprising one or more of the above.

The one or more processors may be further arranged to decrypt, using a public cryptographic key associated with the UE, at least a part of the request thereby to verify ownership of the blockchain asset. The one or more processors may be further arranged to acquire the blockchain asset information responsive to the ownership being verified.

The request may comprise a subscription request, the subscription request being a request to identify one or more blockchain assets associated with the UE and/or a request that the first network function be informed when one or more blockchain assets associated with the UE change. The transmitter may be further arranged to, responsive to the blockchain address being determined, send, to the first network function, a subscription response.

The second network function may be arranged to establish a secure connection with a blockchain node of a blockchain network that stores a blockchain upon which is located the blockchain asset. The transmitter may be further arranged to send, to the blockchain node, via the secure connection, a request for the blockchain asset information associated with the blockchain address. The receiver may be further arranged to receive, from the blockchain node, via the secure connection, the requested blockchain asset information.

The transmitter may be further arranged to send, responsive to determining the blockchain address, a query to an online service. The receiver may be further arranged to receive, from the online service, a list of blockchain assets associated with the blockchain address. The one or more processors may be further arranged to identify the blockchain asset from the received list of blockchain assets.

The second network function may be arranged to periodically determine whether one or more blockchain assets associated with the UE has changed and, responsive to determining that the one or more blockchain assets associated with the UE has changed, send, to the first network function, a notification of said change.

In a further aspect, there is provide a UE comprising a transmitter arranged to send, to a network node in a wireless communication network, blockchain information indicating a blockchain address. The UE further comprises one or more processors arranged to utilize a service in the wireless communication network, the service being utilized as a result of subscription data of the UE being updated dependent on a blockchain asset associated with the blockchain address.

The UE may further comprise a store arranged to store a private cryptographic key. The one or more processors may be further arranged to encrypt at least a part of the blockchain information with the private cryptographic key. The transmitter may be further arranged to send the encrypted blockchain information to the network node.

The blockchain information may comprise an identifier for a blockchain that stores the blockchain asset.

The blockchain information may comprise an identifier of the blockchain asset associated with the blockchain address.

The transmitter may be arranged to send the blockchain information comprised in a registration request, the registration request being a request that the UE be registered with the wireless communication network.

The blockchain asset may be an NFT.

In a further aspect there is provided a method performed by a first network function in a wireless communication network, the method comprising: receiving, by a receiver, blockchain information associated with a user equipment, UE, apparatus, the blockchain information indicating a blockchain address; identifying, by one or more processors, using the blockchain information, a second network function in the wireless communication network; sending, by a transmitter, to the identified second network function, a request for identifying a blockchain asset, the blockchain asset being associated with the blockchain address; receiving, by the receiver, from the second network function, responsive to sending the request, blockchain asset information corresponding to the identified blockchain asset; and updating, by the one or more processors, using the received blockchain asset information, subscription data of the UE apparatus.

In a further aspect there is provided a method performed by a second network function in a wireless communication network, the method comprising: receiving, by a receiver, from a first network function in the wireless communication network, a request for blockchain asset information corresponding to a blockchain asset, the blockchain asset being associated with a user equipment, UE, apparatus, the blockchain asset information being for determining one or more services to be provided to the UE apparatus by the wireless communication network; determining, by one or more processors, using the request, a blockchain address associated with the blockchain asset; acquiring, by the one or more processors, using the blockchain address, the blockchain asset information; and sending, by a transmitter, to the first network function, the blockchain asset information.

In a further aspect there is provided a method performed by user equipment, UE, apparatus, the method comprising: sending, by a transmitter, to a network node in a wireless communication network, blockchain information indicating a blockchain address; and utilising, by one or more processors, a service in the wireless communication network, the service being utilised as a result of subscription data of the UE apparatus being updated dependent on a blockchain asset associated with the blockchain address.

In a further aspect there is provided a network function in a wireless communication network, the network function comprising: a receiver arranged to receive blockchain information associated with a user equipment, UE, apparatus; one or more processors arranged to: using the blockchain information, determine a blockchain address associated with a blockchain asset; using the blockchain address, acquire blockchain asset information corresponding to the blockchain asset; and, using the acquired blockchain asset information, update subscription data of the UE apparatus.

In a further aspect there is provided a method performed by a network function in a wireless communication network, the method comprising: receiving blockchain information associated with a user equipment, UE, apparatus; using the blockchain information, determining a blockchain address associated with a blockchain asset; using the blockchain address, acquiring blockchain asset information corresponding to the blockchain asset; and, using the acquired blockchain asset information, updating subscription data of the UE apparatus.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatuses for enabling a mobile network to identify blockchain assets owned by mobile network users and adapt its operation, and/or service provision to user nodes of the network, based on the identified blockchain assets, or changes in the status of the blockchain assets, will now be described, byway of example only, with reference to the accompanying drawings, in which:

FIG. 1 is a schematic illustration (not to scale) of a network architecture in which a user equipment apparatus, a blockchain network, and a mobile network are in wireless data communication.

FIG. 2 is a schematic illustration (not to scale) of a user equipment apparatus that may be used for implementing the methods described herein.

FIG. 3 is a schematic illustration (not to scale) of a network node that may be used for implementing the methods described herein.

FIG. 4 is a schematic illustration (not to scale) of a procedure for adapting operation of the mobile network based on identifying one or more non-fungible tokens, and/or detecting a change in status of one or more non-fungible tokens, stored on a blockchain and owned by a user of the UE.

FIG. 5 is a process flow chart depicting certain steps of a method to be performed by a first network function (NF) for enabling adaptable operation and service provision of a wireless communication network based on blockchain-recorded blockchain assets of wireless communication network users.

FIG. 6 is a process flow chart depicting certain steps of a method to be performed by a second NF for enabling adaptable operation and service provision of the wireless communication network based on blockchain-recorded blockchain assets of wireless communication network users.

FIG. 7 is a process flow chart depicting certain steps of a method to be performed by a UE for enabling adaptable use of one or more services by the UE in the wireless communication network based on blockchain-recorded blockchain assets associated with the UE.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatuses may be implemented as a hardware circuit comprising custom very-large-scale integration (“VLSI”) circuits or gate arrays, off-the-shelf semiconductors such as logic chips, transistors, or other discrete components. The disclosed methods and apparatuses may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, methods and apparatuses may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed methods and apparatuses are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding figures. Like numbers refer to like elements in all figures.

Several platforms exist today which enable users to buy digital items and store proof of their ownership in a blockchain. For example, a user may visit such a platform, buy a digital image using his/her blockchain wallet and create a record (a.k.a. a token) on a blockchain, which record/token refers to this digital image and proves that he/she is the owner of the digital image. The digital image itself is typically not stored in the blockchain; it could be stored in any (e.g. online) storage, such as a web site. In another example, the user may buy a digital ticket for a football game and create a record (a.k.a. a token) in a blockchain, which record/token contains information about the digital ticket (e.g., a date, a seat number) and proves that he/she is the owner of this digital ticket.

A token stored in the blockchain and containing information about a digital item and proof of ownership of the digital item is commonly referred to as a Non-Fungible Token (NFT). The platforms used to manage (e.g., create, buy, transfer) NFTs are called NFT marketplaces. Essentially, an NFT is a blockchain asset that refers (e.g. uniquely) to an intangible and one-of-a-kind digital item, such as a piece of artwork, an image, an in-game reward, a tweet, etc., thereby acting as proof of authenticity and ownership.

An example of a collection of NFTs stored in a blockchain is shown in Table 1 below. Each NFT comprises at least an identity (which uniquely identifies the NFT within a given collection), the blockchain address of the owner, and a Token URI that points to token information stored in an external resource (i.e., outside the blockchain), such as an online repository. The token information typically contains a description, a name, (optionally) a URI that points to a digital item (e.g., image, video, etc.), and one or more other attributes.

In the example shown below, the token information contains an image URI, meaning that each token represents a digital image and proves the ownership of this digital image. However, in other examples, the token information may not point to an external digital item, i.e., it may not contain an Image field. For instance, when an NFT is a digital ticket, it is possible that the token information only contains text information (e.g., date, event, seat number, etc.) in the one or more other attributes field. When an NFT represents a domain name, the token information may contain the domain name, such as “www.example.audio”, thereby proving ownership of this domain name without the need to point to an external digital item.

TABLE 1
Example of a collection of NFTs stored on a blockchain.

| Token | Blockchain Address | Token Information |
|---|---|---|
| ID | (Identifies the owner) | (Referenced by the Token URI) |
| 1001 | 0x4265de963cdd60629d03FEE2cd32 | Description: “. . .” |
| | 85e6d5ff6015 | Name: ″Cool Cat #1″ |
| | | Image: |
| | | ″https://ipfs.io/ipfs/QmYrxAviWHGugdikgU1Awc8MRtfqx |
| | | MYYRmBuCTMEc5mCAx″ |
| | | Attributes: [. . .] |
| 1002 | 0x1b33EBa79c4DD7243E5a3456fc4 | Description: “. . .” |
| | 97b930Db054b2 | Name: ″Cool Cat #2″ |
| | | Image: |
| | | ″https://ipfs.io/ipfs/QmcxJoj2F24qXpasJ9XKSXyzuEHHJqd |
| | | X9sv7Er5isBxZ95″ |
| | | Attributes: [. . .] |
| . . . | . . . | . . . |

The present inventors have realized that NFTs may be applicable to wireless communication networks, e.g. mobile communication networks. For example, a mobile (e.g., data) subscription may be created as an NFT, i.e. as a token stored in a blockchain that contains some subscription data in the token information, such as a home PLMN identity (MCC/MNC), a phone number, one or more mobile services, etc.

In another case, an NFT may contain one or more mobile network services or features that can be utilized by the owner of the NFT. The following scenario is considered:
A mobile operator creates a list of NFTs in an NFT marketplace. Each NFT is associated with certain mobile communication features. For example, an NFT may provide unlimited mobile data; another NFT may enable access to a particular network slice; another NFT may enable access to a particular LADN or DNN; another NFT may provide membership to a particular Closed Subscriber Group (CSG); another NFT may provide enhanced QoS support, e.g. including ultra-reliable and low latency communication (URLLC), and so on.
A user may buy one or more of these NFTs via the NFT marketplace.
When the user registers with the mobile network, the mobile network identifies the NFT(s) owned by the user and enables one or more features associated with these NFTs (e.g., unlimited mobile data).
An NFT may have a validity period, or validity condition, such that it expires after some time, or upon some condition being met.
A user may transfer (via the marketplace) ownership of a valid NFT, e.g. a non-expired NFT, to a second user, thereby enabling the second user to utilize the mobile features associated with the NFT.

A purpose of this invention may be to specify how the above scenario can be supported or facilitated by a wireless communication network, i.e., how a mobile network may identify the NFTs owned by a mobile user and (optionally) how the mobile network can adapt its operation to provide to NFT owners one or more of the services associated with their NFTs.

In general, a problem addressed by this disclosure is that, conventionally, it tends not to be possible for a mobile network to adapt its operation, e.g. to adapt the services provided to a user equipment apparatus (UE) based on the blockchain asset(s) owned by the UE or user. Mobile users, especially in the context of a metaverse, are expected to acquire more and more digital assets (e.g., vouchers) and to store proof of ownership of such assets in a blockchain. The present inventors have realized that it is desirable for a mobile network to be able to identify such assets owned by mobile users of the network and to adapt, e.g. automatically and/or without express instruction to do so by the UE or user, its operation accordingly. In one envisaged example, the mobile network may be adapted to provide unlimited data services to a mobile user responsive to determining that this user owns a blockchain asset which entitles the user to receive unlimited data services in said mobile network.

This invention may relate to the new Rel-19 study item agreed in 3GPP SA1 on “Localized Mobile Metaverse Services” (see S1-220195), the contents of which are incorporated herein by reference. As mentioned above, in a metaverse, users/participants own digital assets (e.g., virtual land, images, audio, game assets, etc.), and blockchain records (i.e., NFTs) would appear suitable to prove the ownership of these assets. Therefore, when a mobile user of a UE registers with a mobile network, the mobile network may determine the metaverse assets owned by the user and adapt its operation accordingly.

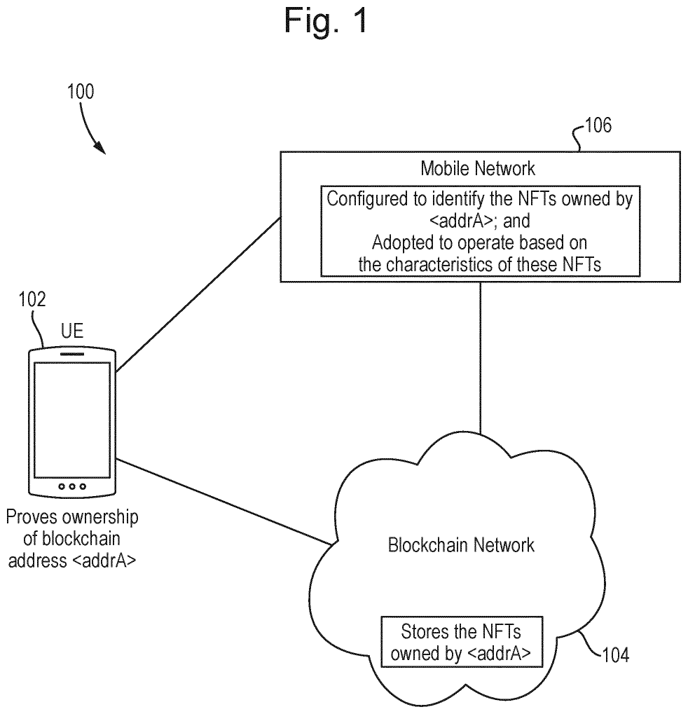

FIG. 1 provides an overview of elements of the disclosure. In particular, FIG. 1 depicts a network architecture 100 in which a UE 102, a blockchain network 104, and a mobile network 106 are in wireless data communication with each other. The blockchain network 104, and in particular blockchain nodes of the blockchain network 104, maintains a blockchain.

The UE 102 maintains a digital wallet and may be used by a user of the UE 102 to buy digital items via one or more, e.g. online, marketplaces. For example, the user of the UE 102 may buy a coupon which provides unlimited data services in a specific Public Land Mobile Network (PLMN). Upon purchase of the coupon, an NFT is created in the blockchain maintained by the blockchain network 104, the NFT storing information about the coupon and identifying the owner of the coupon, i.e. the user of the UE 102.

In this embodiment, the UE 102 also registers with the mobile network 106 and provides information to the mobile network, which enables it to identify the coupon (and all other digital items) owned by the UE 102.

The blockchain maintained by the blockchain network 104 provides secure and decentralized storage of all of the NFTs owned by users of the UEs, e.g. the UE 102, connected to the blockchain network 104, and identifies the owner of each NFT. It also supports the algorithms that enable the management of NFTs, such as NFT creation, transfer, destruction, etc.

In this embodiment, the mobile network 106 identifies one or more NFTs owned by the UE 102 by using relevant information provided by the UE 102 during registration. Based on information stored in the one or more NFTs (e.g., the characteristics/attributes of the one or more NFTs), the mobile network can adapt its operation to provide services to NFT owner(s) that depend on the characteristics of their one or more NFTs.

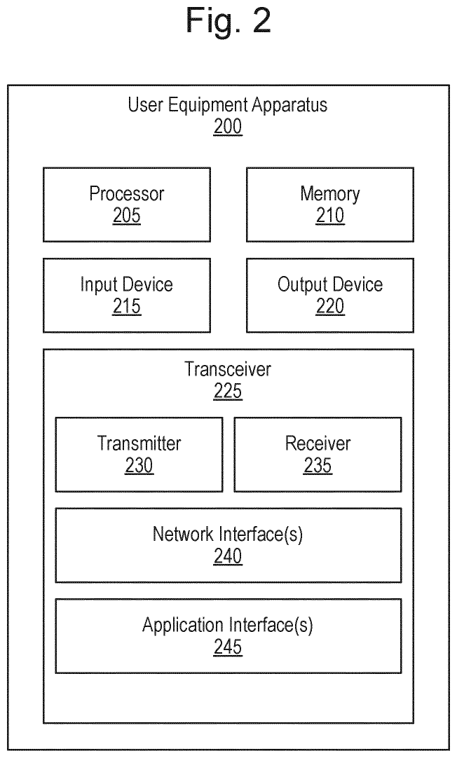

FIG. 2 depicts a user equipment apparatus (UE) 200 that may be used for implementing the methods described herein. The UE 200 is used to implement one or more of the solutions described below. The user equipment apparatus 200 includes a processor 205, a memory 210, an input device 215, an output device 220, and a transceiver 225.

The UE 200 is in accordance with the UEs described in other embodiments herein. In particular, the UE 200 is in accordance with the UE 102 of FIG. 1, and as such the reference numeral 102 is used hereinafter to indicate a UE in accordance with the UE 200.

The input device 215 and the output device 220 may be combined into a single device, such as a touchscreen. In some implementations, the UE 200 does not include any input device 215 and/or output device 220. The UE 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the UE 200 to implement the UE behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implementing a traffic category field. The memory 210 may also store program code and related data, such as an operating system or other controller algorithms operating on the UE 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the UE 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a wireless communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide UL communication signals to a base unit of a wireless communications network. Similarly, the one or more receivers 235 may be used to receive DL communication signals from the base unit. Although only one transmitter 230 and one receiver 235 are illustrated, the UE 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 440.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

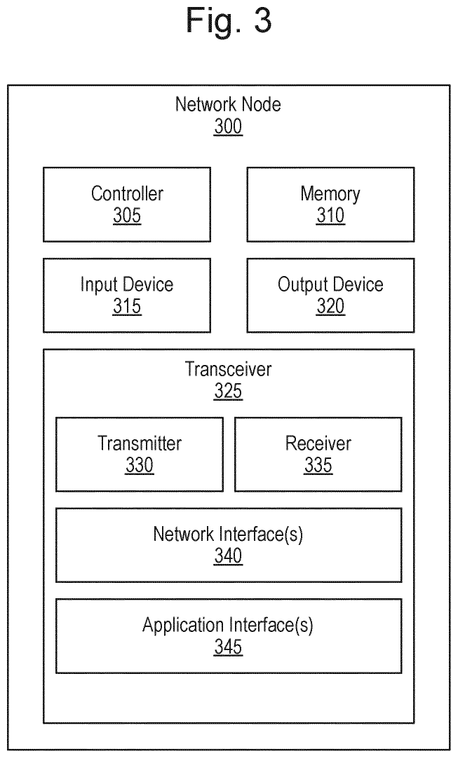

FIG. 3 depicts a network node 300 that may be used for implementing the methods described herein. The network node 300 may be one implementation of an entity in a wireless communications network, e.g. in one or more of the networks in embodiments described herein, e.g. the wireless network 106. The network node 300 may be, for example, the UE 200 described above, or a Network Function (NF) or Application Function (AF), or other entity, of one or more of the networks in embodiments herein, e.g. the wireless network 106. The network node 300 may be a node of the mobile network 106, and/or a node of the blockchain network 104 (i.e. a blockchain node).

The network node 300 includes a controller 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the controller 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 300. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The controller 305 may include any known controller capable of executing computer-readable instructions and/or capable of performing logical operations. For example, the controller 305 may be a microcontroller, a microprocessor, a CPU, a GPU, an auxiliary processing unit, a FPGA, or similar programmable controller. The controller 305 may execute instructions stored in the memory 310 to perform the methods and routines described herein. The controller 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described below. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE 200, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

In an embodiment, a procedure is provided as follows.

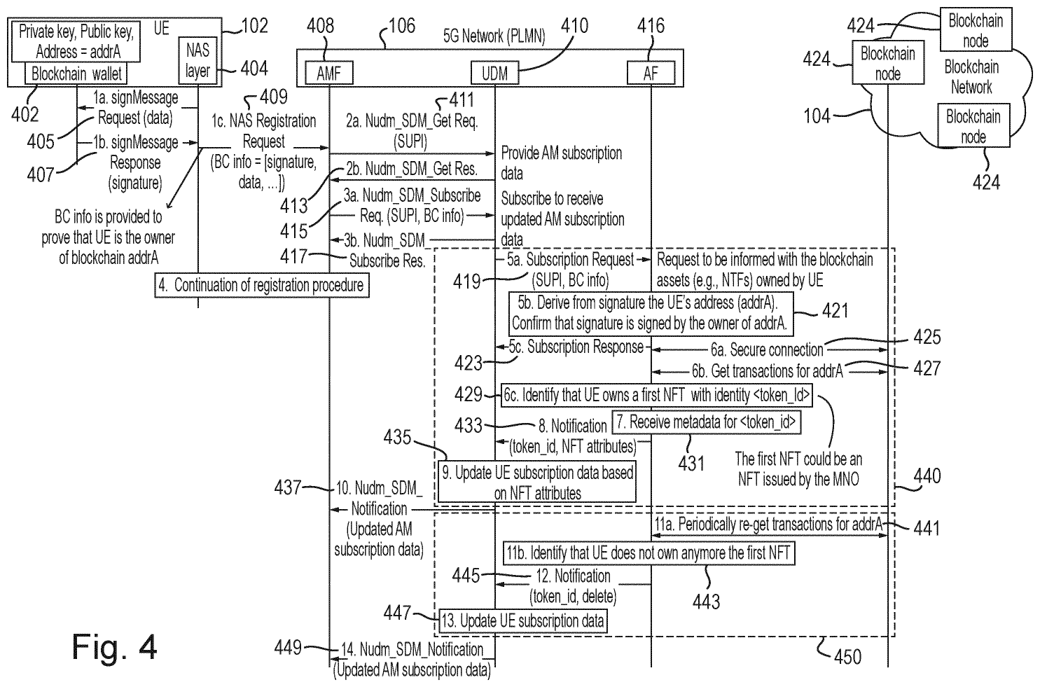

A procedure is schematically depicted in FIG. 4, which is a schematic illustration of a procedure for adapting operation of the mobile network 106 based on the one or more NFTs owned by a user of the UE 102, the user being a user of the mobile network 106. In this embodiment, the one or more NFTs is stored on a blockchain maintained by the blockchain network 104. In this embodiment, the mobile network 106 is a PLMN.

Before the initiation of this procedure, it is assumed that (a) the user of the UE 102 has a blockchain wallet 402, which securely stores a blockchain address (addrA) and cryptographic keys (e.g., at least one private key and at least one public key), and (b) the user of the UE 102 has used the blockchain wallet to buy a digital item (e.g., a mobile coupon). The one or more NFTs has thus been created in the blockchain, and represents this digital item while also providing proof of ownership of this digital item.

The blockchain network 104 may be any blockchain network suitable for supporting NFTs, e.g. the Ethereum network, Solana network, Avalanche network, etc.

In FIG. 4, the access network (e.g., NG-RAN) between the UE 102 and an AMF of the PLMN 106 (in this embodiment, a 5G network) is not shown, for the sake of simplicity.

In this embodiment, the UE 102 first initiates a 5G registration procedure and a Non-access Stratum (NAS) layer 404 sends a NAS Registration Request message to the mobile network 106. The NAS Registration Request message comprises blockchain information (BC info), which is provided to prove that the user of the UE 102 is the owner of the blockchain address, addrA. The NAS layer 402 typically derives the blockchain information, BC info, by interacting with the blockchain wallet 402 in the UE 102. The NAS layer 402 may, for example, request that the blockchain wallet 402 sign a data element using the private key held in the wallet 402, and the blockchain wallet 402 may then return a signature element. Both the signature element and the data element are then included in the blockchain information, BC info, contained within the NAS Registration Request message. The blockchain information, BC info, may contain additional elements such as a blockchain identity, i.e. an identity that refers to a particular blockchain network, such as the Ethereum network, Solana network, Avalanche network, etc.

The requesting by the NAS layer 404 that the blockchain wallet 402 sign a data element using the private key held in the wallet 402 is indicated in FIG. 4 by a single-headed arrow and the reference numeral 405.

The receiving back from the blockchain wallet 402 by the NAS layer 404 a signature element is indicated in FIG. 4 by a single-headed arrow and the reference numeral 407.

The sending of the NAS Registration Request message by the NAS layer 404 to the AMF 408 is indicated in FIG. 4 by a single-headed arrow and the reference numeral 409.

In this embodiment, the AMF 408 retrieves Access Management (AM) subscription data from a UDM 410 of the PLMN 106. The request and retrieval by the AMF 408 of the AM subscription data from the UDM 410 is respectively indicated in FIG. 4 by single-headed arrows and the reference numerals 411 and 413.

In this embodiment, the AMF 408 subscribes with the UDM 410, to receive updated AM subscription data whenever the AM subscription data for the UE 102 changes. In the subscribe request message, the AMF 408 includes the blockchain information, BC info, received from the UE 102. Request of and response to the subscription by the AMF 408 to receive updated AM subscription data from the UDM 410 is respectively indicated in FIG. 4 by single-headed arrows and the reference numerals 415 and 417.

In this embodiment, the 5G registration procedure is then completed using known steps specified in TS 23.502, the contents of which are incorporated herein by reference.

In this embodiment, after receiving the blockchain information, BC info, in the request 415 to subscribe to receive updated AM subscription data, the UDM 410 discovers an Application Function (AF) 416 that can interact with a blockchain network, e.g. the blockchain network 104. The UDM 410 may use the blockchain identity in the blockchain information to discover an AF that can interact with a blockchain indicated by the blockchain identity, i.e. to discover the AF 416. The UDM 410 may, for example, discover the AF 416 by utilizing the (extended) services of a Network Repository Function (NRF).

In this embodiment, the UDM 410 sends a Subscription Request message to the discovered AF 416. The Subscription Request message indicates that the UDM 410 wants to identify the one or more blockchain assets (i.e., in this embodiment, the one or more NFTs) owned by the user of the UE 102, and to be updated when the one or more blockchain assets change, e.g. changes ownership, is generated, is destroyed, etc.

The sending by the UDM 410 of the Subscription Request message to the AF 416 is indicated in FIG. 4 by a single-headed arrow and the reference numeral 419.

The AF 416 then derives the addrA owned by the user of the UE 102 (e.g., by using the signature element contained within the received blockchain information) and verifies, by the public key of the addrA, that the signature has been signed by the private key of the addrA. If this verification is successful, the AF 416 has confirmed that the UE 102 does in fact have access to the private key of the addrA and that, therefore, the user of the UE 102 is the owner of the blockchain wallet 402. Thereafter, the AF 416 sends a subscription response to the UDM 410, acknowledging that it has successfully determined that the user of the UE 102 is indeed the owner of the addrA of the blockchain wallet 402.

The derivation and verification by the AF 416 of the addrA private key ownership of the user of the UE 102 is indicated in FIG. 4 by the reference numeral 421.

The sending by the AF 416 of the subscription response to the UDM 410 is indicated in FIG. 4 by a single-headed arrow and the reference numeral 423.

Using known mechanisms, the AF 416 establishes a secure connection with a blockchain node 422 in the blockchain network 104. The AF 416 then sends a query to the blockchain node 424 to retrieve all of the blockchain transactions associated with the addrA, i.e. to which the addrA was party. These transactions contain transactions by which the one or more NFTs were assigned to, or generated by, the addrA, i.e. owned by the blockchain wallet 402 of the user of the UE 102. By receiving and processing these transactions, the AF 416 may determine which one or more NFTs are owned by the addrA, i.e. owned by the blockchain wallet 402 of the user of the UE 102.

The establishing by the AF 416 of a secure connection with the blockchain node 424 is indicated in FIG. 4 by a double-headed arrow and the reference numeral 425.

The query for, and receipt of, all of the blockchain transactions associated with the addrA by the AF 116 is indicated in FIG. 4 by a double-headed arrow and the reference numeral 427.

In an alternative embodiment, or an addition to the above embodiment, the AF 416 may determine the one or more blockchain assets (i.e., in this embodiment, the one or more NFTs) owned by the addrA, i.e. by the blockchain wallet 402 of the user of the UE 102, by querying an online service, not the blockchain itself. In this embodiment, there exist online services which periodically query the blockchain and derive several types of analytics for every known blockchain address, including NFTs owned by each address. In this embodiment, the operation of the AF 416 is advantageously simplified, as the AF 416 only requests the list of one or more NFTs owned by the addrA, without the need to receive and process a large number of transactions not involving the one or more NFTs owned by the addrA.

In this embodiment, the AF 416 is typically interested in identifying only NFTs which are included in a certain one or more NFT collections, rather than all of the NFTs owned by the addrA. This tends to enable the mobile network 106 to know which NFTs owned by the user of the UE 102 are able to impact the network's operation, e.g. by providing certain mobile services or features to the UE 102. The mobile network 106 is not generally interested in those NFTs owned by the user of the UE 102 which do not function to impact network operation, such as artwork, images, in-game rewards, etc. The certain one or more NFT collections is pre-configured in the AF 416.

In a first case shown in FIG. 4, and indicated with the reference numeral 430, the AF 416 identifies that the user of the UE 102 owns a first NFT of the one or more NFTs, the first NFT having a first token identity, token_id. The first NFT could be included in a first NFT collection of the one or more NFT collections, the first NFT collection containing NFTs, including the first NFT, issued by an operator of the mobile network 106.

The identifying by the AF 416 that the user of the UE 102 owns the first NFT is indicated in FIG. 4 by the reference numeral 429.

The AF 416 subsequently retrieves the token information (a.k.a. metadata) of the first NFT. In many cases, this token information is contained in a JSON file stored in an online repository, the JSON file containing information describing the NFT, such as, a name, an image URI (if the NFT represents a digital image), one or more attributes, etc.

The retrieving by the AF 416 the token information of the first NFT is indicated in FIG. 4 by the reference numeral 431.

In the first case, the AF 416 sends a notification report to the UDM 410, the notification report containing the token identity, token_id, of the first NFT, and the token information (including, for example, the one or more attributes) of the first NFT.

The sending of the notification report by the AF 116 to the UDM 410 is indicated in FIG. 4 by a single-headed arrow and the reference numeral 433.

Based on the token information (e.g. the one or more attributes) in the notification report, the UDM 410 may update the UE subscription data, e.g. to indicate that the UE 102 is permitted to access a certain network slice, or a certain Data Network Name (DNN), or a certain Local Access DNN (LADN), or to indicate some other permission or recommended action with respect to the mobile network 106.

The updating the UE subscription data by the UDM 410 based on the notification report is indicated in FIG. 4 by the reference numeral 435.

If the UE subscription data is updated and the update affects the AM part of the subscription data, then the UDM 410 informs the AMF 408 of this by sending a notification report message to AMF 407.

The informing of the AMF 408 by the UDM 410 is indicated in FIG. 4 by a single-headed arrow and the reference numeral 437.

Thus, actions 419, 421, 423, 425, 427, 429, 431, 433, 435, 437 may, performed together, be considered to be a first procedure 440 for obtaining a first update to the UE subscription data in the mobile network 106 based on attributes of the first NFT, and informing the AMF 48 of the mobile network 106 of this update. That is to say, procedure 440 alters the UE subscription data in the mobile network 106 based on the first NFT identified on the blockchain.

Further to the procedure 440, the AF 416 may periodically re-identify the one or more NFTs (in the one or more NFT collections) owned by the user of the UE 102, and detect possible changes, e.g. a change in NFT ownership within the one or more NFT collections. This can be done either by retrieving from the blockchain a further list of all of the transactions involving the addrA, and processing these transactions, or, preferably, by querying again the online service.

By updating the subscription data of the UE in the wireless communication network, the wireless communication network is configured to provide a service to the UE, the service being dependent on the blockchain asset owned by the blockchain wallet stored on the UE.

The periodically re-identifying by the AF 416 the one or more NFTs owned by the user of the UE 102 is indicated in FIG. 4 by a double-headed arrow and the reference numeral 441.

In an example case shown in FIG. 4, the AF 416 detects that the user of the UE 102 no longer owns the first NFT.

The identifying by the AF 416 that the user of the UE 102 no longer owns the first NFT is indicated by the reference numeral 443.

In this case, the AF 416 sends a further notification report to the UDM 410 containing the token identity, token_id, of the first NFT and an indication to delete this token, since the user of the UE 102 does not own the first NFT anymore.

The sending the further notification report by the AF 416 to the UDM 410 is indicated in FIG. 4 by a single-headed arrow and the reference numeral 445.

Based on the received further notification report, the UDM 410 may further update the UE subscription data, e.g. to indicate that the UE 102 is no longer permitted to access a certain network slice, or a certain Data Network Name (DNN), or a certain Local Access DNN (LADN), or to indicate removal of some other permission or capability, or to recommend an action, with respect to the mobile network 106.

The further updating the UE subscription data by the UDM 410 is indicated in FIG. 4 by the reference numeral 447.

If this further update affects the AM part of the subscription data, then the UDM 410 further informs the AMF 408 by sending a further notification report message to the AMF 408.

The further informing the AMF 408 by the UDM 410 is indicated in FIG. 4 by a single-headed arrow and the reference numeral 449.

Thus, actions 441-449 may, performed together, be considered to be a second procedure 450 for obtaining a further update to the UE subscription data in the mobile network 106 based on a change of ownership of the first NFT, and informing the AMF 408 of the mobile network 106 of this update. That is to say, the second procedure 450 further alters the UE subscription data in the mobile network 106 based on a change of ownership of the first NFT identified on the blockchain.

In the above example, the second procedure 450 further alters the UE subscription data in the mobile network 106 based on a change of ownership of the first NFT identified on the blockchain, because the AF 416 has detected that the user of the UE 102 no longer owns the first NFT. However, in other examples and embodiments, the AF 416 detects a different change, such as newly gained ownership of the first NFT, or generation of the first NFT, or destruction of the first NFT, or some other change in status of the first NFT. In such other examples and embodiments, the second procedure 450 further alters the UE subscription data in the mobile network 106 based on the detected change in status (e.g. new gain, generation, destruction, etc.) of the first NFT identified on the blockchain, because the AF 416 has detected said change in status.

Thus, there is provided a procedure 400 for adapting operation of the mobile network 106 based on identifying one or more NFTs, and/or detecting a change in status of one or more NFTs, owned by the user of the UE 102.

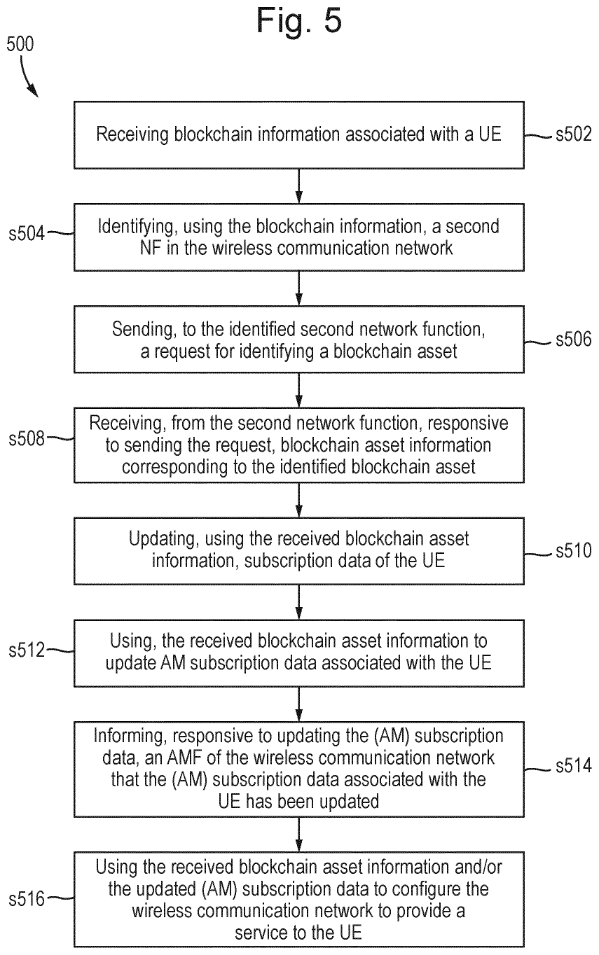

In an embodiment, there is provided a method 500 performed by a first NF in a wireless communication network. FIG. 5 is a process flow chart depicting steps of the method 500.

In this embodiment, the first NF is in accordance the network node 300 described above. The first NF comprises a receiver, in accordance with the receiver 335, a transmitter, in accordance with the transmitter 330, and one or more processors. The first NF may be the UDM 410. The wireless communication network is, in this embodiment, the mobile network 106.

The method 500 includes, at step s502, receiving, by the receiver, blockchain information associated with a UE, the blockchain information indicating a blockchain address. In this embodiment, the UE is in accordance with the UE 102 described in embodiments above, and the blockchain address is in accordance with the addrA described in embodiments above. The blockchain address may be a blockchain wallet address, the blockchain wallet being stored on the UE.

The method 500 includes, at step s504, identifying, by the one or more processors, using the blockchain information, a second NF in the wireless communication network. In this embodiment, the second NF is in accordance with the network node 300 described above. The second NF may be the AF 416. The second NF may be arranged to communicate, or configured to establish a connection, with a blockchain node of a blockchain network that stores a blockchain. In this embodiment, the blockchain node of the blockchain network that stores the blockchain is in accordance with the blockchain node 424 in the blockchain network 104 that stores the blockchain in the embodiments described above.

The method 500 includes, at step s506, sending, by the transmitter, to the identified second NF a request for identifying a blockchain asset, the blockchain asset being associated with, i.e. corresponding to, assigned to, and/or owned by, the blockchain address. In some embodiments, the blockchain asset is the first NFT as described in the above embodiments. The blockchain asset may, in some embodiments, be considered uniquely associated with the blockchain address, e.g. by virtue of a transaction, or event, of, or involving, the blockchain asset on the blockchain, to which transaction or event the blockchain address is uniquely associated. In this embodiment, the sending, by the transmitter, to the identified second NF a request for identifying a blockchain asset may be performed in accordance with the action 419 as described above with reference to the procedure 400 depicted in FIG. 4.

The method 500 includes, at step s508, receiving, by the receiver, from the second NF, responsive to sending the request, blockchain asset information corresponding to the identified blockchain asset. In this embodiment, the receiving, by the receiver, from the second NF, responsive to sending the request, blockchain asset information corresponding to the identified blockchain asset may be performed in accordance with the action 433 described above with reference to the procedure 400 depicted in FIG. 4.

The method 500 includes, at step s510, updating, by the one or more processors, subscription data of the UE using the received blockchain asset information. In this embodiment, the updating, by the one or more processors, subscription data of the UE using the received blockchain asset information may be performed in accordance with the action 435 described above with reference to the procedure 400 depicted in FIG. 4.

In this embodiment, the first NF may be a UDM in accordance with the UDM 410 described with reference to the procedure 400 above.

The method 500 may further include, at step s512, using, by the one or more processors, the received blockchain asset information to update AM subscription data associated with the UE. In this embodiment, the using, by the one or more processors, the received blockchain asset information to update AM subscription data associated with the UE may be performed in accordance with the actions 435 and/or 447 described above with reference to the procedure 400 depicted in FIG. 4.

The method 500 may further include, at step s514, informing, responsive to updating the subscription data (e.g. the AM subscription data), an AMF of the wireless communication network that the (AM) subscription data associated with the UE has been updated. The AMF may be in accordance with the AMF 408 described with reference to the procedure 400 above. In this embodiment, the informing, responsive to updating the AM subscription data, an AMF of the wireless communication network that the AM subscription data associated with the UE has been updated may be performed in accordance with the actions 437 and/or 449 described above with reference to the procedure 400 depicted in FIG. 4.

The method 500 may further include, at step s516, using, by the one or more processors, the received blockchain asset information and/or the updated subscription information (e.g. the updated AM subscription data) to configure the wireless communication network to provide a service to the UE, the service being dependent on the blockchain asset. The service may be an improved or altered service dependent on the blockchain asset.

The method 500 may further include receiving the blockchain information from an AMF of the wireless communication network, the blockchain information being comprised in a subscription request from the AMF requesting that the AMF receives updated AM subscription data for the UE from the first NF. This may be performed in accordance with the action 415 described above with reference to the procedure 400 depicted in FIG. 4.

The blockchain information may comprise an identifier for a blockchain that stores the blockchain asset, in accordance with the blockchain information described in the embodiment of the procedure 400 above. The method 500 may further include identifying, by the one or more processors, the second NF using the identifier for the blockchain.

The method 500 may further include identifying, by the one or more processors, the second NF using services of an NRF. The NRF may be used for NF discovery in 5G systems. In some embodiments, the NRF may be updated to be used for discovering a new NF, e.g. an AF in accordance with the AF 416 described above with reference to the procedure 400, which can provide the blockchain asset information.

The method 500 may further include sending, by the transmitter, to the identified second network function, a subscription request, the subscription request being a request to identify one or more blockchain assets associated with, i.e. corresponding to, assigned to, and/or owned by, the UE, and/or sending a request that the first NF be informed when one or more blockchain assets being associated with, i.e. corresponding to, assigned to, and/or owned by, the UE change. In some embodiments, the blockchain asset is the first NFT as described in the above embodiments. The blockchain asset may, in some embodiments, be considered uniquely associated with the UE, e.g. by virtue of a transaction, or event, of, or involving, the UE, to which transaction or event the UE is uniquely associated. In this embodiment, the sending, by the transmitter, to the identified second NF a request to identify one or more blockchain assets may be performed in accordance with the action 419 as described above with reference to the procedure 400 depicted in FIG. 4.

The requested blockchain asset, and/or the requested blockchain asset information, may comprise one or more of the following: an NFT; an identifier for an NFT; one or more attributes of an NFT; metadata of an NFT; or a report comprising one or more of the above.

The method 500 may further include updating, e.g. by the one or more processors, the subscription data associated with the UE to indicate one or more of the following: that the UE is permitted to access a certain network slice; that the UE is permitted to access a certain DNN; that the UE is permitted to access a certain Local Access DNN (LADN); that the UE is permitted to access a certain Closed Subscriber Group (CSG); that the UE is to be provided with unlimited mobile data; that the UE is to be provided with enhanced QoS support; that the UE is to be provided with ultra-reliable and low-latency communication (URLLC); that the UE is not permitted to access a certain network slice; that the UE is not permitted to access a certain DNN; that the UE is not permitted to access a certain LADN; that the UE is not permitted to access a certain CSG; that the UE is not to be provided with unlimited mobile data; that the UE apparatus is not to be provided with enhanced QoS support; or that the UE is not to be provided with (URLLC).

Thus, a method 500 is provided to be performed by a first NF for enabling adaptable operation and service provision of a wireless communication network based on blockchain-recorded blockchain assets of wireless communication network users.

In an embodiment, there is provided a first NF for performing the method 500. The first NF is the UDM 410 of the mobile network 106 described above with reference to the procedure 400 depicted in FIG. 4.

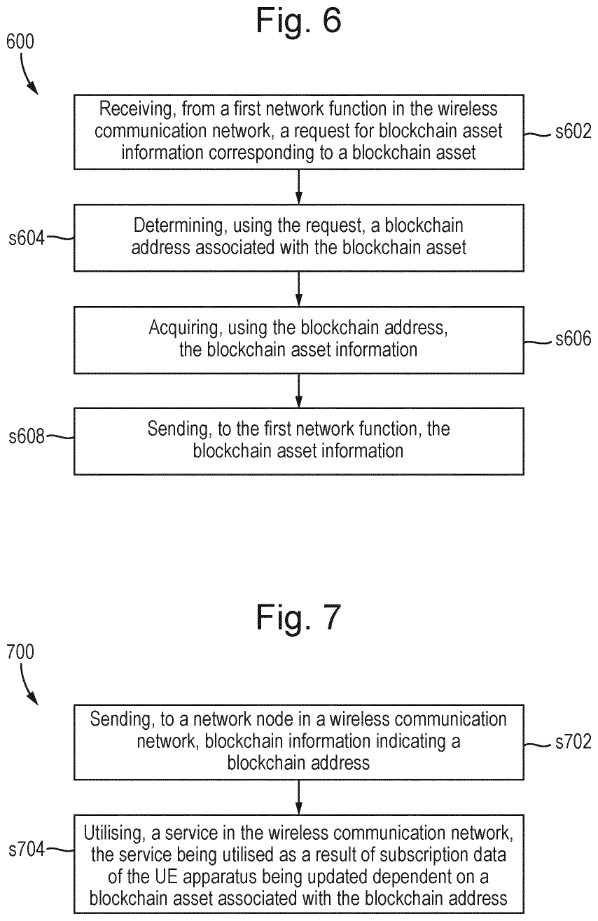

In an embodiment, there is provided a method 600 performed by a second NF in a wireless communication network. FIG. 6 is a process flow chart depicting steps of the method 600.

In this embodiment, the second NF is in accordance the network node 300 described above. The second NF comprises a receiver, in accordance with the receiver 335, a transmitter, in accordance with the transmitter 330, and one or more processors. The wireless communication network is, in this embodiment, the mobile network 106. The second NF may be the AF 416. The second NF may be the second NF of the method 500 described in more detail earlier above with reference to FIG. 5.

The method 600 includes, at step s602, receiving, by the receiver, from a first network function in the wireless communication network, a request for blockchain asset information corresponding to a blockchain asset, the blockchain asset being associated with a UE. The first NF may be the UDM 410. In this embodiment, the UE is in accordance with the UE 102 described in embodiments above and the blockchain address is in accordance with the addrA described in embodiments above. The blockchain address may be a blockchain wallet address, the blockchain wallet being stored on the UE. The blockchain asset information is for determining, e.g. indicating or specifying, one or more services to be provided to the UE by the wireless communication network. The receiving, by the receiver, from the first network function in the wireless communication network, a request for blockchain asset information corresponding to a blockchain asset may be performed in accordance with the action 419 as described above with reference to the procedure 400 depicted in FIG. 4.

The method 600 includes, at step s604, using, by the one or more processors, the request to determine a blockchain address associated with, e.g. corresponding to, assigned to, and/or which owns, the blockchain asset.

The method 600 includes, at step s606, using, by the one or more processors, the blockchain address to acquire the blockchain asset information.

The method 600 includes, at step s608, sending, by the transmitter, to the first NF, the blockchain asset information.

The blockchain asset, and/or the requested blockchain asset information, may comprise one or more of the following: an NFT; an identifier for an NFT; one or more attributes of an NFT; metadata of an NFT; or a report comprising one or more of the above.

The method 600 may further include decrypting, by the one or more processors, using a public cryptographic key associated with the UE, at least a part of the request thereby to verify ownership of the blockchain asset. The decrypting, by the one or more processors, using a public cryptographic key associated with the UE, at least a part of the request thereby to verify ownership of the blockchain asset. may be performed in accordance with the action 429 as described above with reference to the procedure 400 depicted in FIG. 4. The method 600 may further include acquiring, by the one or more processors, the blockchain asset information, responsive to the ownership being verified. The acquiring, by the one or more processors, the blockchain asset information, responsive to the ownership being verified may be performed in accordance with the action 431 as described above with reference to the procedure 400 depicted in FIG. 4.

The request may comprise a subscription request, the subscription request being a request to identify one or more blockchain assets associated with, e.g. corresponding to, assigned to, and/or owned by, the UE and/or a request that the first NF be informed when one or more blockchain assets associated with, e.g. corresponding to, assigned to, and/or owned by, the UE apparatus change.

The method 600 may further include sending, by the transmitter, responsive to the blockchain address being determined, a subscription response to the first NF. This may be performed in accordance with the action 423 as described above with reference to the procedure 400 depicted in FIG. 4.

The method 600 may further include establishing, e.g. by the one or more processors, a secure connection with a blockchain node of a blockchain network that stores a blockchain upon which is located the blockchain asset. In this embodiment, the blockchain node of the blockchain network that stores the blockchain is in accordance with the blockchain node 424 in the blockchain network 104 that stores the blockchain in the embodiments described above. The establishing, e.g. by the one or more processors, a secure connection with a blockchain node of a blockchain network that stores a blockchain upon which is located the blockchain asset may be performed in accordance with the action 425 as described above with reference to the procedure 400 depicted in FIG. 4.

The method 600 may further include sending, by the transmitter, to the blockchain node, via the secure connection, a request for the blockchain asset information associated with the blockchain address.

The method 600 may further include receiving, by the receiver, from the blockchain node, via the secure connection, the requested blockchain asset information. The receiving, by the receiver, from the blockchain node, via the secure connection, the requested blockchain asset information may be performed in accordance with the action 427 and/or 431 as described above with reference to the procedure 400 depicted in FIG. 4.

Instead of or in addition to the second NF establishing the connection with the blockchain node and acquiring blockchain asset information therefrom, the method 600 may further include sending, by the transmitter, responsive to determining the blockchain address, a query to an online service. The method 600 may further include receiving, by the receiver, from the online service, a list of blockchain assets associated with the blockchain address. The method 600 may further include identifying, by the one or more processors, the blockchain asset from the received list of blockchain assets. Blockchain asset information for the identified blockchain asset may then be acquired by the second NF, e.g. from the online service.

The method 600 may further include periodically determining whether one or more blockchain assets associated with, e.g. corresponding to, assigned to, and/or owned by, the UE has changed. The periodically determining whether one or more blockchain assets associated with, e.g. corresponding to, assigned to, and/or owned by, the UE has changed may be performed in accordance with the actions 441 and 443 as described above with reference to the procedure 400 depicted in FIG. 4. The method 600 may further include, responsive to determining that the one or more blockchain assets associated with the UE has changed, sending, to the further first NF, a notification of said change. The sending, to the further first NF, a notification of said change may be performed in accordance with the action 445 as described above with reference to the procedure 400 depicted in FIG. 4.

Thus, a method 600 is provided to be performed by a second NF for enabling adaptable operation and service provision of a wireless communication network based on blockchain-recorded blockchain assets of wireless communication network users.

In an embodiment, there is provided a second NF for performing the method 600. The second NF is an AF, and in particular the AF 416 of the mobile network 106 described above with reference to the procedure 400 depicted in FIG. 4.

In an embodiment, there is provided a method 700 performed by a UE in a wireless communication network. In this embodiment, the UE is in accordance with the UE 102 described in embodiments above and the UE apparatus 200 described above. The wireless communication network is in accordance with the mobile network 106 described in embodiments above. The UE comprises a receiver, in accordance with the receiver 235, a transmitter, in accordance with the transmitter 230, and one or more processors 205.

FIG. 7 is a process flow chart depicting steps of the method 700.

The method 700 includes, at step s702, sending, by the transmitter, to a network node in the wireless communication network, blockchain information indicating a blockchain address. This may be performed in accordance with the action 409 as described above with reference to the procedure 400 depicted in FIG. 4. In this embodiment, the blockchain address is in accordance with the addrA described in embodiments above. The blockchain address may be a blockchain wallet address, the blockchain wallet being stored on the UE. The network node to which the blockchain information is sent may be the AMF 408, the UDM 410, or the AF 416, which are described in more detail earlier above.

The method 700 includes, at step s704, utilizing, by the one or more processors, a service in the wireless communication network, the service being utilized as a result of subscription data of the UE being updated dependent on a blockchain asset associated with, e.g. corresponding to, assigned to, and/or owned by, the blockchain address.

The method 700 may further include storing, by a memory or store of or located on the UE (e.g. the blockchain wallet), a private cryptographic key. The method 700 may further include encrypting, by the one or more processors, at least a part of the blockchain information (for example signature data, blockchain address data, or any other data comprised in the blockchain information) with the private cryptographic key. The method 700 may further include sending, by the transmitter, the encrypted blockchain information to the network node.

The blockchain information may comprise an identifier for a blockchain (e.g. a name of the blockchain, or a block header of the blockchain) that stores the blockchain asset.

The blockchain information may comprise an identifier (e.g. a block header and/or a token ID) of the blockchain asset associated with the blockchain address.

The method 700 may further include sending, by the transmitter, the blockchain information comprised in a registration request, the registration request being a request that the UE be registered with the wireless communication network. This may be performed in accordance with the action 409 as described above with reference to the procedure 400 depicted in FIG. 4.

The blockchain asset may, as in the above embodiments, be an NFT.

Thus, a method 700 is provided to be performed by a UE for enabling adaptable use of one or more services by the UE in a wireless communication network, based on blockchain-recorded blockchain assets associated with the UE.

In an embodiment, there is provided a UE for performing the method 700. The UE is the UE 102 in communication with the mobile network 106 described above with reference to the procedure 400 depicted in FIG. 4.

In the above embodiments, a method for enabling a mobile network to identify blockchain assets owned by mobile network users and adapt its operation, and/or service provision to user nodes of the network, based on the identified blockchain assets, or changes in the status of the blockchain assets, may be provided by two network functions, for example the UDM 410 and the AF 416. In some embodiments, this method or functionality may be provided by a different number of network functions, such as by (only) a single network function. In such embodiments, there may be provided a network function in a wireless communication network, the network function comprising: a receiver arranged to receive blockchain information associated with a user equipment, UE, apparatus; one or more processors arranged to: using the blockchain information, determine a blockchain address associated with a blockchain asset; using the blockchain address, acquire blockchain asset information corresponding to the blockchain asset; and, using the acquired blockchain asset information, update subscription data of the UE apparatus. In such embodiments, there may be provided a method performed by a network function in a wireless communication network, the method comprising: receiving blockchain information associated with a user equipment, UE, apparatus; using the blockchain information, determining a blockchain address associated with a blockchain asset; using the blockchain address, acquiring blockchain asset information corresponding to the blockchain asset; and, using the acquired blockchain asset information, updating subscription data of the UE apparatus.

The methods and apparatuses described herein advantageously enable a mobile network to: determine the blockchain address owned by a user of a UE in a mobile data network; identify the blockchain assets (e.g., NFTs) owned by the user of the UE; and provide services to the UE based on the blockchain assets owned by the user of the UE.

In particular, the methods and apparatuses described herein advantageously allow a mobile network to adapt its operation, e.g. provide enhanced services to the UE based on the blockchain assets owned by the user of the UE

Advantageously, when the mobile network identifies that the user of the UE is no longer the owner of the blockchain asset, the methods and apparatuses described herein tend to provide that the mobile network may further adapt its operation, e.g. stop providing enhanced services to UE based on the blockchain assets owned by the user of the UE.

Advantageously, the methods and apparatuses described herein tend to allow that changes in status of a collection of NFTs belonging to the user of the UE may be periodically monitored by the mobile network, the mobile network being advantageously configured to further adapt its operation (e.g. change, enhance, or stop service provision, provide enhanced QoS services, and/or provide access to special features) based on, i.e. dependent upon, one or more such changes in status, without being expressly prompted to do so by the user of the NFT or any other entity external to the mobile network.

Advantageously, the methods and apparatuses described herein provide for altering operation of the mobile network of a UE based on blockchain entries, thereby providing a secure, decentralized and verifiable method of adapting network operation (e.g. changing, enhancing, or stopping service provision, providing enhanced QoS services, and/or providing access to special features).

Advantageously, the methods and apparatuses described herein may include (in the case of a method) querying, or (in the case of an apparatus) an AF configured to query, an online service, rather than the blockchain itself, to ascertain the blockchain assets belonging to the user of the UE and/or derive several types of analytics for blockchain addresses. This tends to simplify operation and reduce data throughput and computational workload of the AF, as the AF need only request the list of blockchain assets owned by the user of the UE, and does not need to receive and process a large number of transactions involving blockchain assets other than those owned by the user of the UE.

It should be noted that the above-mentioned methods and apparatuses illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed methods and apparatuses may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatuses may be practiced in other specific forms. The described methods and apparatuses are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A network entity comprising a first network function, the network entity comprising:
at least one memory; and
at least one processor coupled with the at least one memory and configured to cause the network entity to:
receive blockchain information associated with a user equipment (UE), the blockchain information indicating a blockchain address;
identify a second network function based on the blockchain information;
send, to the identified second network function, a request for identifying a blockchain asset associated with the blockchain address;
receive, from the second network function and in response to the request, blockchain asset information corresponding to the blockchain asset; and
update subscription data of the UE based on the blockchain asset information.

2. The network entity of claim 1, wherein the first network function is a User Data Management (UDM) function.

3. The network entity of claim 1, wherein the at least one processor is configured to cause the network entity to:
use the blockchain asset information to update Access Management (AM) subscription data associated with the UE apparatus; and
responsive to updating the AM subscription data, inform an AM Function (AMF) that the AM subscription data associated with the UE has been updated.

4. The claim 1, wherein the at least one processor is configured to cause the network entity to provide a service to the UE using the blockchain asset information, wherein the service is dependent on the blockchain asset.

5. The network entity of claim 1, wherein the at least one processor is configured to cause the network entity to receive the blockchain information in a subscription request from an Access Management Function (AMF), the subscription request requesting that the AMF receive updated Access Management (AM) subscription data for the UE from the first network function.

6. The network entity of claim 1, wherein:
the blockchain information comprises an identifier for a blockchain that stores the blockchain asset; and
the at least one processor is configured to cause the network entity to identify the second network function using the identifier for the blockchain.

7. The network entity of claim 6, wherein the least one processor is configured to identify the second network function using a Network Repository Function (NRF).

8. The network entity claim 1, wherein the transmitter is arranged at least one processor is configured to send a subscription request to the second network function, the subscription request comprising a request to identify one or more blockchain assets associated with the UE or a request that the first network function be informed when one or more blockchain assets associated with the UE change.

9. The network entity of claim 1, wherein the requested blockchain asset comprises one:
a non-fungible token (NFT);
an identifier for an NFT;
one or more attributes of an NFT;
metadata of an NFT;
a report comprising one or more of the foregoing; or
a combination thereof.

10. The network entity of claim 1, wherein the at least one processor is configured to update the subscription data associated with the UE to indicate that the
UE is permitted to access a certain network slice;
UE is permitted to access a certain Data Network Name (DNN);
UE is permitted to access a certain Local Access DNN (LADN);
UE is permitted to access a certain Closed Subscriber Group (CSG);
UE is to be provided with unlimited mobile data;
UE is to be provided enhanced Quality of Service (QoS) support;
UE is to be provided with ultra reliable and low latency communication (URLLC);
UE is not permitted to access a certain network slice;
UE is not permitted to access a certain DNN;
UE is not permitted to access a certain LADN;
UE is not permitted to access a certain CSG;
UE is not to be provided with unlimited mobile data;
UE is not to be provided enhanced QoS support;
UE is not to be provided with URLLC; or
a combination thereof.

11. A network entity comprising a second network function, the network entity comprising:
at least one memory; and
at least one processor coupled with the at least one memory and configured to cause the network entity to:
receive, from a first network function, a request for blockchain asset information corresponding to a blockchain asset associated with a user equipment (UE), the blockchain asset information indicating one or more services to-be provided to the UE;
determine a blockchain address associated with the blockchain asset based on the request;
acquire the blockchain asset information based on the blockchain address; and
send, to the first network function, the blockchain asset information.

12. The network entity of claim 11, wherein the second network function is an Application Function (AF).

13. The network entity of claim 11, wherein the blockchain asset comprises:
a non-fungible token (NFT);
an identifier for an NFT;
one or more attributes of an NFT;
metadata of an NFT;
a report comprising one or more of the above foregoing; or
a combination thereof.

14. The network entity of claim 11, wherein the at least one processor is configured to:
decrypt, using a public cryptographic key associated with the UE, at least a part of the request thereby to verify ownership of the blockchain asset; and
acquire the blockchain asset information responsive to the ownership being verified.

15. The network entity of claim 11, wherein:
the request comprises a subscription request to identify one or more blockchain assets associated with the UE or a request that the first network function be informed when one or more blockchain assets associated with the UE change; and
the at least one processor is configured to, responsive to the blockchain address being determined, send a subscription response to the first network function.

16. The network entity of claim 11, wherein the at least one processor is configured to cause the network entity to:
establish a secure connection with a blockchain node of a blockchain network that stores a blockchain where the blockchain asset is located;
send, to the blockchain node via the secure connection, a request for the blockchain asset information associated with the blockchain address; and
receive, from the blockchain node via the secure connection, the blockchain asset information.

17. The network entity of claim 11, wherein the at least one processor is configured to:
send, responsive to determining the blockchain address, a query to an online service;
receive, from the online service, a list of blockchain assets associated with the blockchain address; and
identify the blockchain asset from the list of blockchain assets.

18. The network entity of claim 11, wherein the at least one processor is configured to:
periodically determine whether one or more blockchain assets associated with the UE has changed; and
responsive to determining that one or more blockchain assets associated with the UE has changed, send, to the first network function, a notification of the change.

19. A user equipment (UE) for wireless communication, the UE comprising:
at least one memory; and
at least one processor coupled with the at least one memory and configured to cause the UE to:
send, to a network node in a wireless communication network, blockchain information indicating a blockchain address; and
utilise utilize a service in the wireless communication network responsive to subscription data of the UE being updated based on a blockchain asset associated with the blockchain address.

20-29. (canceled)

30. A processor comprising a first network function for wireless communication, comprising:
at least one controller coupled with at least one memory and configured to cause the processor to:
receive blockchain information associated with a user equipment (UE), the blockchain information indicating a blockchain address;
identify a second network function based on the blockchain information;
send, to the identified second network function, a request for identifying a blockchain asset associated with the blockchain address;
receive, from the second network function, and in response to the request, blockchain asset information corresponding to the blockchain asset; and
update subscription data of the UE based on the blockchain asset information.
